(19) United States
(12) Patent Application Publication
(10) Pub. No.: US 2023/0336611 A1
(43) Pub. Date: Oct. 19, 2023

(54) REMOTE OPERATING METHOD AND REMOTE OPERATING SYSTEM FOR HUMAN-MACHINE INTERFACE

(71) Applicant: DELTA ELECTRONICS, INC., Taoyuan City (TW)

(72) Inventors: Chun-Fu LAI, Taoyuan City (TW); Chia-Hung LIU, Taoyuan City (TW); Chun-Fu LIN, Taoyuan City (TW)

(21) Appl. No.: 17/840,422

(22) Filed: Jun. 14, 2022

(30) Foreign Application Priority Data
Apr. 14, 2022 (CN) 202210392759.3

(51) Int. Cl. H04L 67/02; G06F 9/451

(52) U.S. Cl. CPC H04L 67/02; G06F 9/451

(57) ABSTRACT

A remote operating method for a HMI is disclosed and includes following steps: obtaining a component information of at least one control component of the HMI when an inquiring command is received; transmitting the component information to a remote electronic device by the HMI; generating and providing an operation related information according to the component information by a translating software of the remote electronic device; receiving an operating activity with respect to the control component; translating the operating activity to a component operating instruction by the translating software and transmitting the component operating instruction to the HMI; and, triggering the control component correspondingly by the HMI based on the component operating instruction.

### BACKGROUND OF THE DISCLOSURE

### Technical Field

The disclosure relates to a human-machine interface, particularly relates to a remote operating method and a remote operating system for a human-machine interface.

### Description of Related Art

Many industrial equipment are equipped with the human-machine interface (HMI) nowadays for the user to operate the industrial equipment through the HMI.

In general, the HMI provides a touch screen, or is equipped with physical function buttons. When the user has operation requirement, the user may touch or press corresponding control component referring to the description displayed on the HMI to make the industrial equipment execute corresponding function.

Following the development of Internet, part of the users have the demand of remote operation. When the user wants to operate the HMI remotely, the user mainly accesses the screen of the HMI through webpage, and operate the HMI on the webpage. Otherwise, the user may duplicate and share the screen of the HMI to the remote device through virtual network computing (VNC) software to operate the HMI from the remote device.

However, the method of transforming the screen of the HMI to webpage needs special webpage design, and thus the costs of adding extra webpage design and interface authentication are needed. Further, the method of duplicating and sharing the screen of the HMI to the remote device through VNC is not applicable to the HMI with less hardware resources and slow processing speed.

In view of this, the inventors have devoted themselves to the aforementioned related art, researched intensively try to solve the aforementioned problems.

### SUMMARY OF THE DISCLOSURE

The disclosure provides a remote operating method and a remote operating system for a human-machine interface, which transform the operating activity of the user for the HMI to a command for the user to remotely operate the HMI through the other electronic devices.

In some embodiments of the disclosure, a remote operating method for a human-machine interface (HMI) is applied to the HMI connected with a remote electronic device. The remote electronic device is configured to run a translation software, and the method includes:
a) receiving an inquiring command;
b) obtaining a component information of at least one control component in the HMI based on the inquiring command, wherein the component information includes a component type and a component description of the control component;
c) transmitting the component information to the remote electronic device;
d) performing a translation procedure to the component information by the translation software to correspondingly generate an operation related information, and providing the operation related information through the remote electronic device;
e) accepting an operating activity with respect to the control component;
f) translating the operating activity to a component operating instruction correspondingly by the translation software, and transmitting that to the HMI; and
g) triggering the control component according to the component operating instruction by the HMI.

In some embodiments of the disclosure, a remote operating system for a human-machine interface (HMI) includes:
a translation software, configured to run in a remote electronic device; and
the HMI, connected with the remote electronic device through a transmitting unit and including an integrated unit, the integrated unit configured to obtain a component information of at least one control component in the HMI when receiving an inquiring command, and transmit the component information to the remote electronic device through a communication protocol corresponding to the transmitting unit, wherein the component information includes a component type and a component description of the control component;
wherein the translation software is configured to perform a translation procedure to the component information to generate and provide an operation related information correspondingly, and translate an operating activity into a component operating instruction correspondingly and transmit that to the HMI, when accepting an operating activity with respect to the control component;
wherein the integrated unit is configured to trigger the control component after receiving the component operating instruction.

Comparing to the related art, the disclosure is used to only capture and transmit the component information of each control component in the HMI to the remote electronic device. The disclosure does not need to largely modify the existing HMI, does not need the designed webpage for remote connection, and does not need to use VNC software. Therefore, the purpose of remote operation may be achieved with minimal cost and minimal hardware requirement.

### BRIEF DESCRIPTION OF THE DRAWINGS

FIG. 1 is a block diagram of the remote operating system of the disclosure in accordance with the first embodiment.

FIG. 2 is a schematic diagram of the remote operating system of the disclosure in accordance with the first embodiment.

FIG. 3 is a flowchart of the remote operating system of the disclosure in accordance with the first embodiment.

FIG. 4A is a schematic diagram of the control component of the disclosure in accordance with the first embodiment.

FIG. 4B is a schematic diagram of the control component of the disclosure in accordance with the second embodiment.

FIG. 4C is a schematic diagram of the control component of the disclosure in accordance with the third embodiment.

FIG. 5 is a schematic diagram of the remote operation of the disclosure in accordance with the first embodiment.

FIG. 6 is a schematic diagram of the remote operation of the disclosure in accordance with the second embodiment.

FIG. 7 is a flowchart of the connection authentication of the disclosure in accordance with the first embodiment.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

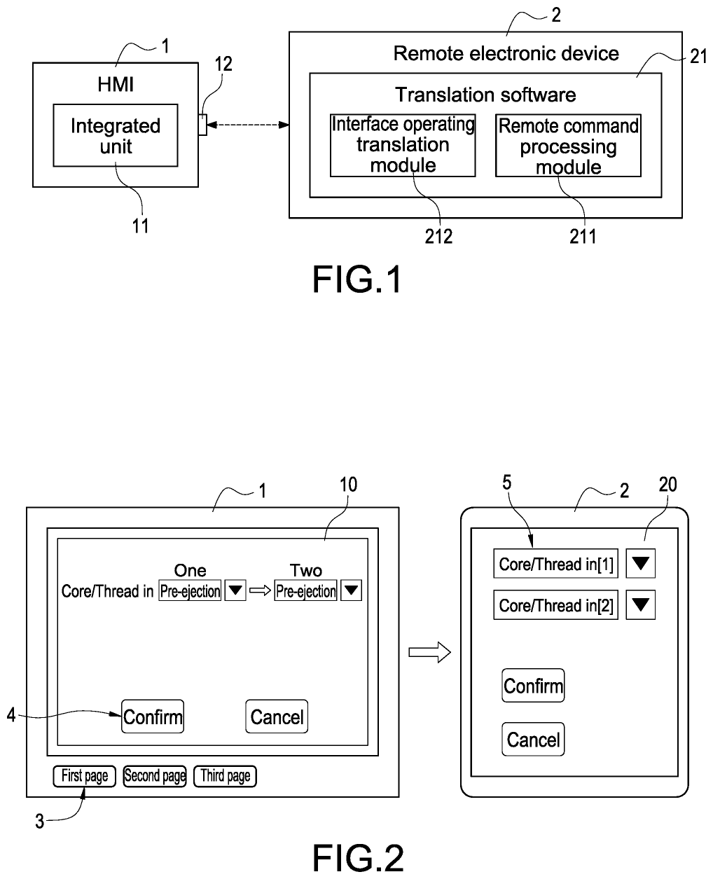

Please refer to FIG. 1, which is a block diagram of the remote operating system of the disclosure in accordance with the first embodiment. The disclosure mainly discloses a remote operating system for a human machine interface (HMI) (abbreviated as the operating system hereafter). The operating system is configured to integrate the information such as descriptions, attributes and corresponding control content, etc., of the control component in the HMI 1 to transmit that to the remote electronic device 2. The remote electronic device 2 is configured to generate and provide the optimized command interface based on the information. The user may give an instruction to the specific control component on the HMI 1 through the remote electronic device 2, thereby simulating that the user directly performs the operating activity of touch control to the control component on the HMI 1.

As shown in FIG. 1, the operating system of the disclosure includes the HMI 1 and the translation software 21 developed relatively to the HMI 1. The translation software 21 is configured to run in the remote electronic device 2, and the HMI 1 is connected with the remote electronic device 2 through the transmitting unit 12 thereof.

In some embodiments, the remote electronic device 2 may be all kinds of electronic devices with different hardware capabilities. For example, the remote controller without screen, the personal computer or laptop with general screen and general input interface (such as keyboard/mouse), or the smart mobile device or tablet computer with touch screen, etc., here is not intended to be limiting.

The remote electronic device 2 has a processor (not shown in figures). When the processor is configured to execute the translation software 21, the remote electronic device 2 establishes a connection with the HMI 1, and generate corresponding command interface based on the information of the HMI 1 to provide for the user. Therefore, the user may give an instruction to the HMI 1 through the remote electronic device 2 to simulate directly performing the operating activity of touch control to the HMI 1.

The transmitting unit 12 may be physical serial port, wireless transmitting unit or network line port, etc., here is not intended to be limiting. In some embodiments, the transmitting unit 12 is configured to use the communication protocol such as RS-232, RS-485, Bluetooth, ethernet, Wi-Fi, or controller area network bus (CAN bus), etc., here is not intended to be limiting.

As shown in FIG. 1, the HMI 1 has an integrated unit 11. Specifically, the firmware of the HMI 1 of the disclosure is modified to internally generate the integrated unit 11. In other words, the integrated unit 11 of the disclosure is a firmware module in the HMI 1.

The HMI 1 is configured to establish the connection with the remote electronic device 2 through the transmitting unit 12. When the HMI 1 receives the inquiring command transmitted by the remote electronic device 2 through the transmitting unit 12, the HMI 1 is configured to obtain the component information of at least one control component (for example, the control component 4 shown in FIG. 2) therein through the firmware manner (that is, through the integrated unit 11). Further, the HMI 1 is configured to transmit the component information to the remote electronic device 2 through the communication protocol used by the transmitting unit 12 for the translation software 21 in the remote electronic device 2 to process.

In some embodiments, the integrated unit 11 may have a built-in instruction set. The instruction set at lease includes a set of remote inquiring commands. When the remote electronic device 2 establishes the connection with the HMI 1, the remote electronic device 2 is configured to transmit the inquiring command consistent with the instruction set for the HMI 1. If the integrated unit 11 determines that the inquiring command is consistent with the instruction set, the integrated unit 11 is configured to accept the inquiring request from the remote electronic device 2.

In some embodiments, the screen of the HMI 1 includes the component related to the operation (that is, the control component 4) and the component non-related to the operation (such as the logo, graphics, color, contact information, descriptive text, etc.). The difference between the disclosure and the related art is that the operating system of the disclosure does not duplicate and transmit whole screen of the HMI 1 to the remote electronic device 2 for displaying. Instead, the operating system of the disclosure captures the component (that is, the control component 4) related to the operation through the integrated unit 11 and solely transmits the information related to the operation to the remote electronic device 2. In other words, the information being transmitted to the remote electronic device 2 through hand-shaking procedure is the information related to the component which is operable on the HMI 1 and capable of generating the operating activity.

When the remote electronic device 2 receives the information, the remote electronic device 2 is configure to perform processing and optimization through the translation software 21 to generate corresponding command interface and provide that to the user for reference. After the user looks the command interface, the user may perform the operating activity correspondingly. With respect to the technical solution of the disclosure, the problem of the additional design cost for the operating interface provided through webpage may be overcome, and the problem of non-applicable to VNC software of screen sharing for the equipment in low cost or with incapable hardware capability may also be overcome.

Please refer to FIG. 2, which is a schematic diagram of the remote operating system of the disclosure in accordance with the first embodiment. The HMI 1 may include multiple control components 4 based on the project of original design. In some embodiments, the integrated unit 11 is configured to transmit the component information of one or multiple control components 4 displayed on the screen 10 of the HMI 1 to the remote electronic device 2. After the remote electronic device 2 receives the component information, the remote electronic device 2 is configured to perform the translation procedure through the translation software 21 to generate the operation related information 5 correspondingly and provide that for the user. In the embodiment of FIG. 2, the translation software 21 is configured to display the generated operation related information 5 on the screen 20 of the remote electronic device 2, here is not intended to be limiting.

In the disclosure, the translation software 21 is configured to determine the presenting manner of the component information on the remote electronic device 2 according to the hardware capability of the remote electronic device 2, and execute the translation procedure according to the presenting manner. For example, if the remote electronic device 2 is the remote controller without the screen, the translation software 21 is configured to translate the component information into the operation related information 5 in a voice manner, and play the operation related information 5 on the remote controller through the voice manner. If the remote electronic device 2 is the electronic device with general screen or touch screen, the translation software 21 is configured to translate the component information into the operation related information 5 in a manner of text, graphics, voice or the combination, etc., and provide the operation related information 5 on the electronic device through the screen or the voice manner.

The aforementioned descriptions are part of the embodiments of the disclosure, the manner of the operation related information 5 is not limited hereto.

Specifically, when using the operating system of the disclosure, the user may still check the screen 10 of the HMI 1. Therefore, the requirements of the operation related information 5 provided by the remote electronic device 2 are for the user to understand content of each control component 4 on the HMI 1 and the executable operating activity, the presenting manner of the operation related information 5 is not limited hereto.

It is worth mentioning that the component information mainly includes the component type (that is, the attribute of the control component 4) and the component description (including name, name, function tip or menu content, etc., of the control component 4) of the control component 4. In the disclosure, the translation software 21 is configured to execute the translation procedure based on the component type and the component description of the control component 4, and generate the operation related information 5 of the control component 4 correspondingly. In the disclosure, the translation software 21 is configured to assemble a command interface through the operation related information 5 received from all of the control components 4, and provide the command interface for the user to operate through the remote electronic device 2.

After the operation related information 5 is generated, the translation software 21 may be configured to continuously monitor the remote electronic device 2, and determine whether the remote electronic device 2 receive the operating activity with respect to any control component 4. When the remote electronic device 2 accepts the operating activity with respect to one of the control components 4, the translation software 21 is configured to translate the operating activity into the component operating instruction correspondingly and transmit back to the HMI 1.

In the embodiment of FIG. 2, the remote electronic device 2 is using the tablet computer with touch screen as an example, and the multiple operation related information 5 are displayed on the touch screen in a manner of the combination of text and graphics (that is, box) to describe the corresponding control component 4 on the HMI 1. FIG. 2 is solely one embodiments of the disclosure, the presenting manner of the operation related information 5 is not limited hereto.

In the embodiment of FIG. 2, the operating activity with respect to the specific control component 4 indicates the activity of directly touching the operation related information 5 of describing the specific control component 4 on the touch screen. In some other embodiments, the operating activity may indicate the activity of selecting the operation related information 5 of describing the specific control component 4 through the keyboard or mouse, or the activity of selecting the specific control component 4 through voice instruction, etc., here is not intended to be limiting.

Specifically, the operating system of the disclosure is configured to transform or expand the operating activity from the user to the HMI 1 through the remote electronic device 2 and translation software 21. As described above, based on the hardware capability of the remote electronic device 2, the user may perform the operation by direct touch control, using the input interface such as keyboard or mouse, or in a voice manner, to make the remote electronic device 2 generate the component operating instruction, after looking to the operation related information 5 provided by the remote electronic device 2.

When the HMI 1 receives the component operating instruction from the remote electronic device 2, the integrated unit 11 is configured to trigger corresponding control component 4 on the HMI 1 based on the received component operating instruction. As a result, the operating activity of the user directly triggering the control component 4 on the HMI 1 may be simulated.

As shown in FIG. 1, the translation software 21 of the disclosure mainly includes a remote command processing module 211 and an interface operating translation module 212. Specifically, the translation software 21 records the computer executable program code, after the processor of the remote electronic device 2 executes the computer executable program code, the remote electronic device 2 may virtually divide the translation software 21 into the remote command processing module 211 and the interface operating translation module 212 based on executed functions. In other words, the remote command processing module 211 and the interface operating translation module 212 are software modules.

In some embodiments, the remote command processing module 211 is configured to provide the protocol communication capability between the HMI 1 and the remote electronic device 2, after the remote electronic device 2 establishes the connection with the HMI 1. As a result, the remote electronic device 2 may transmit the component information and the component operating instruction with the HMI 1 through the remote command processing module 211.

In some embodiments, the interface operating translation module 212 is configured to monitor the status of the remote electronic device 2 to translate the component information provided by the HMI 1 into the operation related information 5 capable of being represented by the remote electronic device 2. Further, the interface operating translation module 212 is configured to monitor the operating activity of the user on the remote electronic device 2, and translate the operating activity into the component operating instruction which is understandable for the HMI 1.

It is worth mentioning that some types of the HMI 1 may be arranged to multiple pages (for example, first page, second page and third page, etc.) based on the operating requirement. Each page has one or multiple control components 4 corresponding to different functions. Further, the HMI 1 may be arranged with the physical switch buttons 3 corresponding to the number of the pages. In the embodiment of FIG. 2, when the switch button 3 corresponding to the first page is pressed, the HMI 1 is switched to display one or multiple control components 4 of the first page; when the switch button 3 corresponding to the second page is pressed, the HMI 1 is switched to display one or multiple control components 4 of the second page, and so on.

In some embodiments, when the HMI 1 receives the inquiring command output by the remote electronic device 2, the integrated unit 11 is configured to solely capture the component information of one or multiple control components 4 in the present page of the HMI 1, and transmit the component information to the remote electronic device 2. As a result, the consistency between the HMI 1 and remote electronic device 2 of providing information may be achieved.

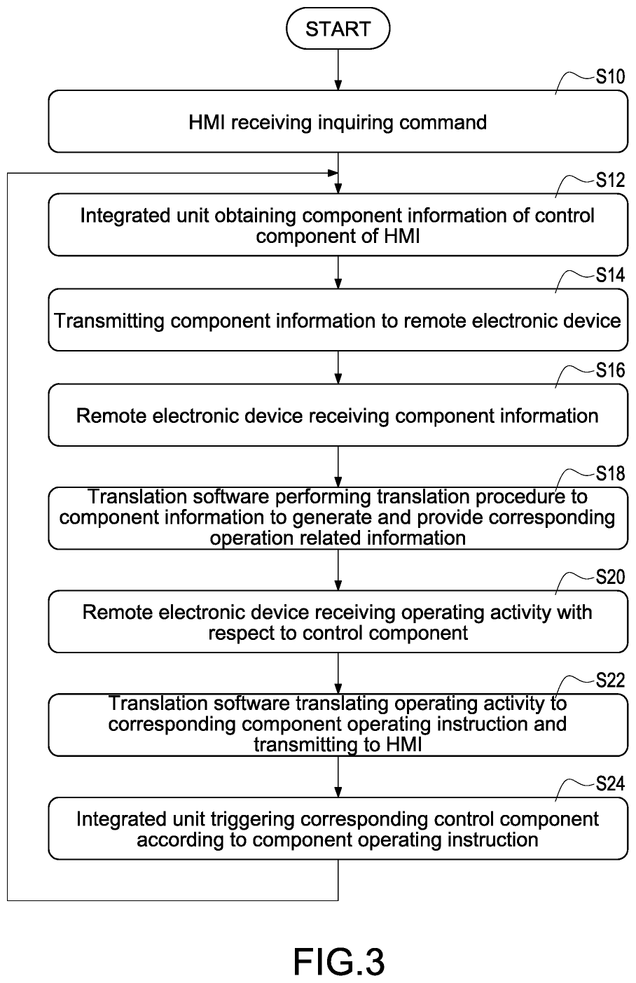

Please refer to FIG. 1 to FIG. 3, FIG. 3 is a flowchart of the remote operating system of the disclosure in accordance with the first embodiment. The disclosure further provides a remote operating method for the HMI (abbreviated as the operating method hereafter). The operating method is mainly applied to the operating system shown in FIG. 1 and FIG. 2.

As shown in FIG. 3, first, the HMI 1 is connected with the remote electronic device 2 used by the user. After the user operates the remote electronic device 2 (for example, triggering the remote electronic device 2 to execute the translation software 21), the HMI 1 is configured to receive the inquiring command output by the remote electronic device 2 through the transmitting unit 12 (step S10).

When the HMI 1 receives the inquiring command, the HMI 1 understands that the remote electronic device 2 is going to provide corresponding command interface for the user to operate with respect to the HMI 1. At the same time, the integrated unit 11 of the HMI 1 obtains the component information of at least one control component 4 in the HMI 1 based on the inquiring command (step S12). In some embodiments, the component information at least includes the component type and the component description of the control component 4.

As described above, the HMI 1 may be arranged to have multiple pages. Each page has one or multiple control components 4. In the step S12, the integrated unit 11 is configured to obtain the component information of all control components 4 in the page presently displayed by the screen 10 of the HMI 1, when receiving the inquiring command, here is not intended to be limiting.

Specifically, apart from the component type and the component description, the component information may selectively include the existed information of the HMI 1, for example, page identification code, page name, page description, component identification code and component supplementary information, etc. The command interface generated after translated by the translation software 21 may be ampler through adding the information to the component information and providing that to the remote electronic device 2. As a result, the user may perform correct operation through the command interface (that is, the operation related information 5) provided by the remote electronic device 2.

After the step S12, the integrated unit 11 is configured to transmit the obtained component information to the remote electronic device 2 (step S14). Specifically, the integrated unit 11 mainly perform processing to the component information based on the communication protocol supported by the transmitting unit 12 of the HMI 1, and transmits the processed component information to the remote electronic device 2 through the transmitting unit 12.

In some embodiments, the transmitting unit 12 may be the serial port, wireless transmitting unit or network line port, etc., and the communication protocol may be RS-232, RS-485, Bluetooth, ethernet, Wi-Fi, or CAN bus, etc., here is not intended to be limiting.

After the step S14, the remote electronic device 2 is configured to receive the component information from the HMI 1 (step S16). Afterward, the remote electronic device 2 is configured to perform the translation procedure to the component information through the translation software 21 to generate corresponding operation related information 5, and further provide the operation related information 5 (step S18).

Specifically, after the user connects the remote electronic device 2 with the HMI 1, the user may continuously confirm the update of the remote electronic device 2, that is, confirming whether the remote electronic device 2 provides the operation related information 5 based on content of the HMI 1. As a result, the user may use the remote electronic device 2 to further operate the HMI 1.

In some embodiments, the remote electronic device 2 is configured to receive the component information from the HMI 1 through the remote command processing module 211 in the translation software 21, and perform the translation procedure to the component information through the interface operating translation module 212 in the translation software 21, here is not intended to be limiting.

In some embodiments, the translation software 21 is configured to execute the translation procedure based on the fixed strategy. That is, regardless of the hardware capability of the remote electronic device 2, the translation software 21 is configured to adopt a fixed manner to translate the component information to generate the operation related information 5 in a fixed manner, and provide the generated operation related information 5 in a fixed presenting manner. For example, regardless of whether the remote electronic device 2 has the touch screen or not, the translation software 21 is configured to translate the component information into the operation related information 5 in a voice manner, and play the generated operation related information 5 in the voice manner. Further, the translation software 21 is configured to accept the voice control from the user.

In some other embodiments, in the step S18, the translation software 21 is configured to determine the presenting manner of the component information on the remote electronic device 2 according to the hardware capability of the remote electronic device 2, and execute corresponding translation procedure to the component information according to the determined presenting manner.

For example, if the remote electronic device 2 does not have screen, the translation software 21 may determine to play the component information in the voice manner, thereby translating the component information into the operation related information 5 in the voice manner. For another example, if the remote electronic device 2 has a touch screen, the translation software 21 may determine to display the component information in a manner of touch graphics, thereby translating the component information into the operation related information 5 in a manner of the combination of text and graphics. The aforementioned description are part of the embodiments of the disclosure, here is not intended to be limiting.

As described above, based on different hardware capabilities, the translation software 21 may present the operation related information 5 in a manner of text, graphics, voice or the combination, etc., after translating, here is not intended to be limiting.

After the remote electronic device 2 provides the operation related information 5, the translation software 21 may be configured to continuously monitor the status of the remote electronic device 2 and determine whether the remote electronic device 2 receives the operating activity with respect to any control component 4 from external (step S20). In the disclosure, the operating activity may be, for example, direct touch control, selecting through input interface or voice instruction, etc., here is not intended to be limiting.

In the step S20, if the remote electronic device 2 is determined to be receiving the operating activity with respect to any control component 4 from external, the translation software 21 is configured to translate the operating activity to the component operating instruction corresponding to the control component 4, and transmit back to the HMI 1 (step S22).

Specifically, after the HMI 1 transmits the component information to the remote electronic device 2 in the step S14, the HMI 1 is configured to wait and continuously determine whether to receive the component operating instruction transmitted by the remote electronic device 2.

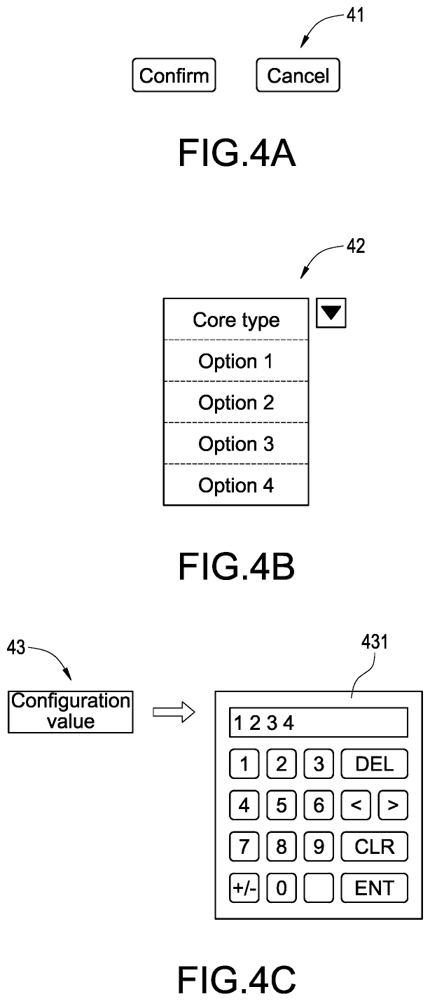

Please refer to FIG. 2, FIG. 4A, FIG. 4B and FIG. 4C, FIG. 4A to FIG. 4C are the schematic diagrams of the control component of the disclosure in accordance with the first embodiment to the third embodiment.

In the disclosure, the component type of the control component 4 in the HMI 1 may be a button component (such as the button component 41 shown in FIG. 4A), a menu component (such as the menu component 42 shown in FIG. 4B) or an input component (such as the input component 43 shown in FIG. 4C), and the component description may be a name, a function tip or a menu content of the control component 4 in the HMI 1.

The embodiment in FIG. 4A discloses two button components 41, and the component descriptions of the two button components 41 are “Confirm” and “Cancel”, respectively. In the embodiment, after the translation software 21 performs the translation procedure to the component information, the operation related information 5 indicating the selecting function of confirmation and cancel is generated. After the user looks the operation related information 5, the user may understand that the present screen of the HMI 1 includes the two button components 41 of “Confirm” and “Cancel”.

On the HMI 1, the operations from the user with respect to the button components 41 includes pressing, releasing and clicking. Therefore, when the remote electronic device 2 receives the operating activity with respect to the button component 41, the translation software 21 is configured to translate the operating activity to a press operating instruction, a release operating instruction or a click operating instruction corresponding to the button component 41.

The embodiment in FIG. 4B discloses the menu component 42, and the component description of the menu component 42 is “Core type”. In the embodiment, after the translation software 21 performs the translation procedure to the component information, the operation related information 5 indicating the menu function of core type is generated. After the user looks the operation related information 5, the user may understand that the present screen of the HMI 1 includes the menu components 42 of “Core type”.

On the HMI 1, the operations from the user with respect to the menu components 42 include selecting. Therefore, when the remote electronic device 2 receives the operating activity with respect to the menu component 42, the translation software 21 is configured to translate the operating activity to a select operating instruction corresponding to the menu component 42.

In some embodiments, the component information received by the remote electronic device 2 further includes content information (for example, the menu content such as “Option 1”, “Option 2” in FIG. 4B) of the menu component 42. When the user operates with respect to one of the menu components 42, the translation software may directly provide the menu content of the menu component 42 (for example, displaying on the screen 20, or playing through voice manner) to provide the user to further perform selecting operation.

In some other embodiments, when the user operates with respect to one of the menu components 42, the translation software 21 transforms the operating activity to corresponding component operating instruction and transmits that back to the HMI 1, and request the HMI 1 for the menu content of the menu component 42 through the component operating instruction (described hereafter). In the embodiment, the operating system may be configured to effectively restrict the data size of the component information to ensure the smooth communication between the HMI 1 and the remote electronic device 2.

The embodiment in FIG. 4C discloses the input component 43, and the component description of the input component 43 is “Configuration value”. In the embodiment, after the translation software 21 performs the translation procedure to the component information, the operation related information 5 indicating the input function of configuration value is generated. After the user looks the operation related information 5, the user may understand that the present screen of the HMI 1 includes the input components 43 of “Configuration value”.

On the HMI 1, the operations from the user with respect to the input components 43 include inputting.

Therefore, when the remote electronic device 2 receives the operating activity with respect to the input component 43, the translation software 21 is configured to further provide an input interface 431 correspondingly. When the user inputs corresponding value through the input interface 431 (for example, inputting through the keyboard or voice manner), the translation software 21 translates the inputting activity and inputting content to an input operating instruction corresponding to the input component 43.

The aforementioned description are part of the embodiments of the disclosure. The operating system and operating method of the disclosure are applicable to all kinds of component types supported by the existing HMI 1, and are not limited to the button component 41, the menu component 42 and the input component 43 shown in FIG. 4A to FIG. 4C.

Referring back to FIG. 1 and FIG. 3, after the step S22, the HMI 1 may receive the component operating instruction transmitted from the remote electronic device 2 through the transmitting unit 12. At the same time, the integrated unit 11 is configured to trigger corresponding control component 4 in the HMI 1 according to the component operating instruction (step S24). As a result, the operating activity from the user to the remote electronic device 2 may be simulated as the operating activity of touch control from the user to the control component 4 in the HMI 1.

Specifically, after the user performs the operating activity to the remote electronic device 2 in the step S20, the user may continuously confirm whether the screen of the HMI 1 is refreshed. As a result, the user may determine whether the HMI 1 triggers the control component 4 corresponding to the operating activity from the user.

In some embodiments, after the operating activity is completed, the user may confirm the refreshed screen of the HMI 1 after the operating activity is done to determine whether to perform the next operating activity through the remote electronic device 2. In some other embodiment, after the operating activity is completed, the user may continuously monitor the HMI 1 to periodically refresh screen to obtain the related information continuously provided by the HMI 1 after the corresponding control component 4 is triggered.

In the first embodiment, the translation software 21 is configured to translate the first button component on the HMI 1 and generate the first operation related information. After the user looks the first operation related information, the user performs the clicking operation with respect to the first button component. In the embodiment, the integrated unit 11 is configured to click the first button component according to the received component operating instruction in the step S24.

In the second embodiment, the translation software 21 is configured to translate the first menu component on the HMI 1 and generate the second operation related information. After the user looks the second operation related information, the user performs the selecting operation with respect to the first menu component. In the embodiment, the integrated unit 11 is configured to select the first menu component according to the received component operating instruction in the step S24.

In the third embodiment, the translation software 21 is configured to translate the first input component on the HMI 1 and generate the third operation related information. After the user looks the third operation related information, the user performs the inputting operation with respect to the first input component. In the embodiment, the integrated unit 11 is configured to add corresponding data to the first input component according to the received component operating instruction in the step S24.

The aforementioned description are part of the embodiments of the disclosure, here is not intended to be limiting.

Please also Refer to FIG. 4B and FIG. 4C, in the disclosure, the translation software 21 is configured to continuously determine whether the user's operation is completed. For example, if the user performs the clicking operation with respect to one of the menu components 42, the translation software 21 returns to the step S12 to obtain the menu content of the menu component 42 from the HMI 1 and waits for the user to further perform the selecting operation. For another example, if the user performs the clicking operation with respect to one of the input components 43, the translation software 21 returns to the step S12 to obtain the acceptable input content of the input component 43 from the HMI 1 and waits for the user to further perform the inputting operation.

If the user's operation is determined to be completed, the translation software 21 may terminate the operating method of the disclosure. For example, the translation software 21 may control the remote electronic device 2 to terminate the connection with the HMI 1.

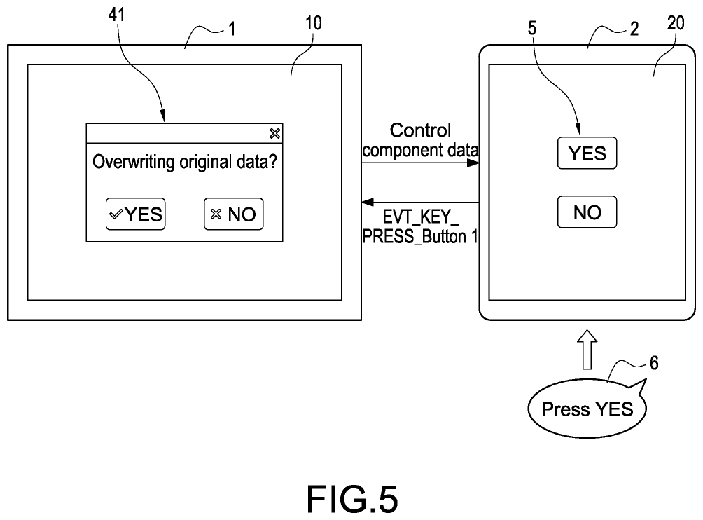

Please refer to FIG. 1 to FIG. 5, FIG. 5 is a schematic diagram of the remote operation of the disclosure in accordance with the first embodiment. FIG. 5 is used to describe the information stream when the user operate the button component 41 on the HMI 1 through the remote electronic device 2.

In the embodiment of FIG. 5, the screen 10 of the HMI 1 has two button components 41. When the HMI 1 receives the inquiring command from the remote electronic device 2, the integrated unit 11 obtains the component information of the button components 41 and transmits that to the remote electronic device 2. The remote electronic device 2 performs the translation procedure to the component information through the translation software 21 to generate corresponding operation related information 5 and display that on the screen 20.

After the user looks the operation related information 5 displayed on the remote electronic device 2, the user may operate the specific button component 41 based on the operation related information 5. For example, in the embodiment of FIG. 5, the user may output the input operation 6 through the voice instruction of “Press YES”. After the input operation 6 from the user is received, the translation software 21 is configured to process the input operation 6 based on the operation related information 5 to translate the input operation 6 to the component operating instruction corresponding to the button component 41 with the component description of “YES”. In the embodiment of FIG. 5, the component operating instruction uses “EVT_KEY_PRESS_Button 1” as an example. “Button 1” from “EVT_KEY_PRESS_Button 1” may be, for example, the component number of the button component 41 corresponding to the component operating instruction, here is not intended to be limiting.

Specifically, the component operating instruction is the original instruction of the button component 41 in the HMI 1. After the HMI 1 receives the component operating instruction transmitted by the remote electronic device 2, the integrated unit 11 may directly trigger corresponding button component 41 according to the component operating instruction to make the HMI 1 execute corresponding function of the button component 41. As a result, the operating activity of the user directly triggering the button component 41 of the HMI 1 may be simulated.

As described above, the disclosure is configured to transform the touch activity of the user on the HMI 1 to the voice inputting activity on the remote electronic device 2 to expand the operating flexibility of the HMI 1.

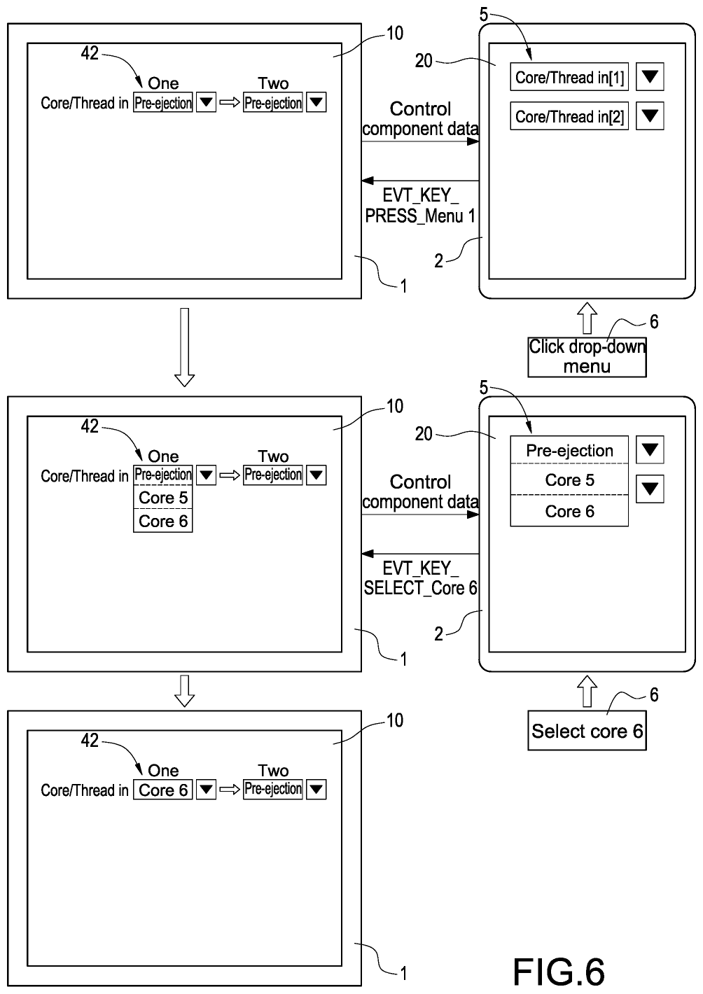

Pleaser refer to FIG. 1 to FIG. 6, FIG. 6 is a schematic diagram of the remote operation of the disclosure in accordance with the second embodiment. FIG. 6 is used to describe the information stream when the user operate the menu component 42 on the HMI 1 through the remote electronic device 2.

In the embodiment of FIG. 6, the screen 10 of the HMI 1 has two menu components 42. When the HMI 1 receives the inquiring command from the remote electronic device 2, the integrated unit 11 obtains the component information of the menu component 42 and transmits that to the remote electronic device 2. The remote electronic device 2 performs the translation procedure to the component information through the translation software 21 to generate corresponding operation related information 5 and display that on the screen 20.

After the user looks the operation related information 5 displayed on the remote electronic device 2, the user may click the specific menu component 42 based on the operation related information 5. For example, in the embodiment of FIG. 6, the user may touch the screen 20 of the remote electronic device 2 to realize the input operation 6 of “Click drop-down menu”. After the input operation 6 from the user is received, the translation software 21 is configured to process the input operation 6 based on the operation related information 5 to translate the input operation 6 to the component operating instruction corresponding to the menu component 42 with the component description of “Core/Thread in [1]”. In the embodiment of FIG. 6, the component operating instruction uses “EVT_KEY_PRESS_Menu 1” as an example. “Menu 1” from the “EVT_KEY_PRESS_Menu 1” may be, for example, the component number of the menu component 42 corresponding to the component operating instruction, here is not intended to be limiting.

The component operating instruction is the original instruction of the menu component 42 in the HMI 1. After the HMI 1 receives the component operating instruction transmitted by the remote electronic device 2, the integrated unit 11 may directly click corresponding menu component 42 according to the component operating instruction. As a result, the operating activity of the user directly touching the menu component 42 of the HMI 1 may be simulated.

When the menu component 42 is being clicked, the HMI 1 is configured to open the menu component 42 according to the instruction and display the menu content of the menu component 42. Thereafter, the integrated unit 11 takes the menu content as a portion of the component information of the menu component 42, and transmits the component information including the menu content to the remote electronic device 2.

After the remote electronic device 2 receives the refreshed component information, the translation software 21 performs the translation procedure to the component information to refresh originally displayed operation related information 5 again. As shown in FIG. 6, the refreshed operation related information 5 displays all menu contents of the menu component 42, including “Pre-ejection”, “Core 5”, “Core 6”, etc.

When the user checks the operation related information 5 in the remote electronic device 2, the user may select the specific menu content in the menu component 42 based on the operation related information 5. For example, the user may touch the screen 20 of the remote electronic device 2 to realize the input operation 6 of “Select core 6”. After the input operation 6 from the user is received, the translation software 21 is configured to process the input operation 6 based on the operation related information 5 to translate the input operation 6 to corresponding component operating instruction, and transmit that back to the HMI 1. In the embodiment of FIG. 6, the component operating instruction uses “EVT_KEY_SELECT_Core 6” as an example.

After the HMI 1 receives the component operating instruction transmitted by the remote electronic device 2, the integrated unit 11 is configured to select corresponding menu content (that is, core 6) in the menu component 42 according to the component operating instruction. As a result, the operating activity of the user directly selecting the option of “Core 6” in the menu component 42 of the HMI 1 may be simulated.

As described above, the operating system and operating method of the disclosure are performing the transmission of the component information and the component operating instruction after the connection between the HMI 1 and the remote electronic device 2 are established. For assuring the safety of data, the operating system and operating method of the disclosure may further include a connection protecting mechanism before transmitting data.

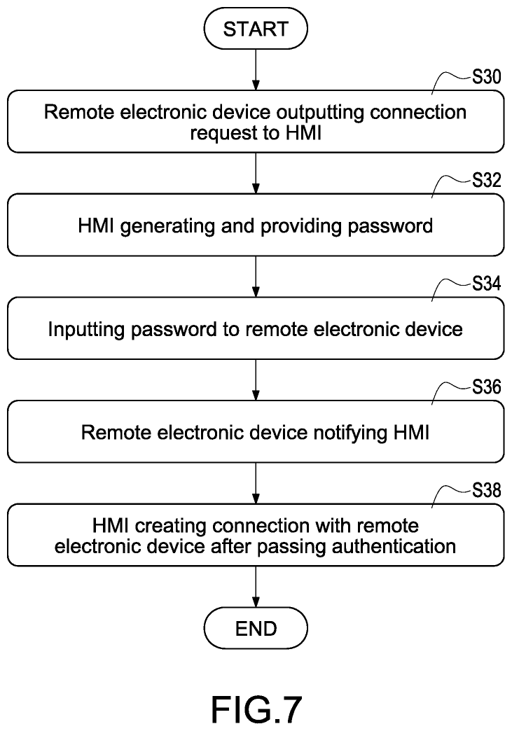

Please refer to FIG. 1 to FIG. 7, FIG. 7 is a flowchart of the connection authentication of the disclosure in accordance with the first embodiment.

As shown in FIG. 1, FIG. 2 and FIG. 7, when the user has the demand of operating the HMI 1, the user may use the remote electronic device 2 to output the connection request to the HMI 1 (step S30). When the HMI 1 receives the connection request from the remote electronic device 2, the HMI 1 may generate corresponding password instantaneously, and provide that to the remote electronic device 2 (step S32).

In some embodiments, the HMI 1 may generate a 2D barcode recording the password in the step S32, and display the 2D barcode on a screen 10 of the HMI 1. In some other embodiments, after the HMI 1 generates the password (for example, number, text symbol or the combination) in the step S32, the HMI 1 may display that on the screen 10 or transmit that to the remote electronic device 2 in a manner of message.

After the step S32, the remote electronic device 2 may be inputted with the password (step S34). In some embodiments, the remote electronic device 2 may be configured to scan the 2D barcode of the HMI 1 displayed on the screen 10 to be inputted with the password. In some other embodiments, the remote electronic device 2 is configured to input the password provided by the HMI 1 to the corresponding authentication interface automatically or manually, here is not intended to be limiting.

After the password is inputted, the remote electronic device 2 is configured to notify the HMI 1 that the password is inputted (step S36). At the same time, the HMI 1 may authenticate the remote electronic device 2, and establish the connection with the remote electronic device 2 after the authentication is passed (step S38).

By using the password, the improper operation such as someone using unauthenticated equipment to remotely operate the HMI 1 may be avoided, and the risk of causing the user to be damaged may also be prevented.

As described above, by the technical solutions of transmitting the component information of the HMI to the remote electronic device and letting the user give the operating instruction on the remote electronic device, the disclosure may achieve the purpose of transforming and expanding the operating activity from the user to the HMI under the condition of low cost and less hardware resource.

While this disclosure has been described by means of specific embodiments, numerous modifications and variations may be made thereto by those skilled in the art without departing from the scope and spirit of this disclosure set forth in the claims.

1. A remote operating method for a human-machine interface (HMI), applied to the HMI connected with a remote electronic device, the remote electronic device configured to run a translation software, the HMI comprising a built-in control component set, and the method comprising:
a) receiving an inquiring command;
b) in response to the inquiring command, obtaining a component information of at least one control component in the HMI based on the built-in control component set, wherein the component information comprises a component type and a component description of the control component;
c) transmitting the component information to the remote electronic device;
d) performing a translation procedure to the component information by the translation software to correspondingly generate an operation related information, and providing the operation related information through the remote electronic device;
e) accepting an operating activity with respect to the control component;
f) translating the operating activity to a component operating instruction correspondingly by the translation software, and transmitting that to the HMI; and
g) triggering the control component according to the component operating instruction by the HMI.

2. The remote operating method according to claim 1, further comprising: arranging multiple pages in the HMI, wherein each page comprises at least one of the control component; and
the b) further comprising:
obtaining the component information of the control component in a present page when the HMI receives the inquiring command.

3. The remote operating method according to claim 1, wherein the component type comprises a button component, a menu component or an input component, and the component description comprises a name, a function tip or a menu content of the control component in the HMI.

4. The remote operating method according to claim 3, wherein the f) further comprises: translating the operating activity to a press operating instruction, a release operating instruction or a click operating instruction corresponding to the button component, a select operating instruction corresponding to the menu component, or an input operating instruction corresponding to the input component.

5. The remote operating method according to claim 1, wherein the d) further comprises: determining a presenting manner of the component information on the remote electronic device according to a hardware capability of the remote electronic device, and performing the translation procedure to the component information according to the presenting manner.

6. The remote operating method according to claim 1, wherein the operation related information is presented by a text, a graphics, a voice or a combination thereof.

7. The remote operating method according to claim 1, wherein before the a), the method further comprises:
a01) requesting connection from the remote electronic device to the HMI;
a02) after the a01), generating and providing a password by the HMI;
a03) inputting the password to the remote electronic device;
a04) after the a03), notifying the HMI by the remote electronic device; and
a05) establishing connection between the HMI and the remote electronic device after the HMI authenticating successfully.

8. A remote operating system for a human-machine interface (HMI), the system comprising:
a translation software, configured to run in a remote electronic device; and
the HMI, comprising a built-in control component set, connected with the remote electronic device through a transmitting unit and comprising an integrated unit, the integrated unit configured to obtain a component information of at least one control component in the HMI based on the built-in control component set when receiving and in response to an inquiring command, and transmit the component information to the remote electronic device through a communication protocol corresponding to the transmitting unit, wherein the component information comprises a component type and a component description of the control component;
wherein the translation software is configured to perform a translation procedure to the component information to generate and provide an operation related information correspondingly, and translate an operating activity into a component operating instruction correspondingly and transmit that to the HMI, when accepting an operating activity with respect to the control component;
wherein the integrated unit is configured to trigger the control component after receiving the component operating instruction.

9. The remote operating system according to claim 8, wherein the translation software is configured to generate a remote command processing module and an interface operating translation module after being executed by the remote electronic device, the remote command processing module is configured to provide a protocol communication capability between the HMI and the remote electronic device to transmit the component information and the component operating instruction, and the interface operating translation module is configured to translate the component information into the operation related information and translate the operating activity into the component operating instruction.

10. The remote operating system according to claim 9, wherein the component type comprises a button component, a menu component or an input component, and the component description comprises a name, a function tip or a menu content of the control component in the HMI.

11. The remote operating system according to claim 10, wherein the interface operating translation module is configured to translate the operating activity into a press operating instruction, a release operating instruction or a click operating instruction corresponding to the button component, a select operating instruction corresponding to the menu component, or an input operating instruction corresponding to the input component.

12. The remote operating system according to claim 9, wherein the interface operating translation module is configured to determine a presenting manner of the component information on the remote electronic device according to a hardware capability of the remote electronic device, and perform the translation procedure to the component information according to the presenting manner.

13. The remote operating system according to claim 12, wherein the operation related information is presented by a text, a graphics, a voice or a combination thereof.

14. The remote operating system according to claim 8, wherein the HMI is configured to comprise, each page comprises at least one of the control component, the integrated unit is configured to obtain the component information of the control component in a present page of the HMI when receiving the inquiring command.

15. The remote operating system according to claim 8, wherein the communication protocol comprises RS-232, RS-485, Bluetooth, ethernet, Wi-Fi, or controller area network bus (CAN bus).
